(19) United States
(12) Patent Application Publication
(10) Pub. No.: US 2011/0020641 A1
(43) Pub. Date: Jan. 27, 2011

(54) TAMPER RESISTANT SECURITY SEALING TAPE AND THE PROCESS OF MANUFACTURING THE SAME

(75) Inventors: Pradip Hiralal Shroff, Mumbai (IN); Ashok Biswas, Mumbai (IN); Somnath Bhattacharya, Mumbai (IN)

Correspondence Address: SCHMEISER OLSEN & WATTS, 18 E UNIVERSITY DRIVE, SUITE # 101, MESA, AZ, 85201, US

(73) Assignee: PRS SOLUTIONS PRIVATE LIMITED, Mumbai (IN)

(21) Appl. No.: 12/935,135

(22) PCT Filed: Jul. 7, 2008
(86) PCT No.: PCT/IN2008/000434

§ 371 Date: Sep. 28, 2010

(30) Foreign Application Priority Data
Apr. 3, 2008 (IN) 785/MUM/2008

(51) Int. Cl. B32B 7/12

(52) U.S. Cl. 428/354

(57) ABSTRACT

A tamper resistant security sealing tape comprising four or more layers and the method of manufacturing the same. The said tape once stuck properly can not be removed and flakes in bits and pieces. The tape has a fragile base substrate which is a cast polymeric film, a layer of pressure sensitive adhesive on one side of the base substrate, a polymeric film strip which is partially laminated on the other side of the base substrate using pressure sensitive adhesive, a release liner protecting the base substrate adhesive, and optionally an indicia or logo printed on the said polymeric strip. The base substrate is of very low breaking strength and pressure sensitive adhesive is of very high tack and peel strength even on low energy surfaces and at low temperatures. The tape softens and melts at high temperatures and dissolves and gives tacky solution when in contact with solvents.

### FIELD OF INVENTION

The present invention relates to a “tamper resistant security sealing tape and the method of manufacturing the same”. The said tape comprises of four or more layers and it is heat destructible, solvent destructible and tamper resistant. The base substrate of the said tape is extremely fragile with a low breaking strength and it is coated with a pressure sensitive adhesive. The said tape has very high peel strength on any surface including articles having very low surface energy such as transparent bags made out of polyethylene and/or polypropylene film that are commonly used by duty free shops and banking industry. One of the layers of the tape in present invention is a partially laminated polymeric film which provides the desired strength to the tape for handling in an auto dispensing machine and also generates differential strength of the tape at the middle and both sides thereby tearing the weaker film when attempt is made to open the sealed package bearing the said tape. This combination of low strength substrate and highly aggressive adhesive makes the product practically impossible to remove thereby resisting unauthorized opening of the package or any attempt made for tampering the sealed package. Further, any attempt to remove the tape from the package on which it has been applied is not possible in single piece due to the unique properties of the said tape having base substrate which softens and distorts when heat is applied by any means and dissolves when any commercially available solvents and/or chemicals is used.

### DESCRIPTION OF THE PRIOR ART

Containers having tamper-evident closures are commonly used in industries in which the contents of the containers must be maintained in tight security, for example, in the banking industry. One form of container commonly used in banking and other industries is a bag, pouch or envelope formed of a polymeric material such as polyethylene. The opening in this type of package is commonly closed with a pressure-sensitive adhesive located on its one side. To close the package, a peel-back strip covering the free side of the adhesive is removed, and the exposed surface of the adhesive is then pressed against the opposite side. Generally, if these existing closures are forced open, the pressure-sensitive adhesive and/or other parts of the package will distort and break apart, so as to provide an indication that the it has been opened. While, this principle works well for bags made out of fibrous substance such as paper, cardboard etc. they do not show distortion or breaking of package material for bags made out of polymeric films such as Polyethylene, Polypropylene etc. Various types of tamper-evident tapes and labels for use with bags, envelopes, and other packages have been available for several years. Most of such tamper-evident tapes and labels have been formed with layers in addition to the pressure-sensitive adhesive to provide an evidence of tampering. Such adhesive tapes when peeled from the surface on which they are stuck leaves part of adhesives on the surface as a message, which was not visible in the original tape. The message remains visible even when the adhesive tape is replaced exactly at its original position. U.S. Pat. No. 5,060,848 describes a tamper evident seal that uses a layer of nitrocellulose or acrylic ink that breaks apart in a selected pattern when the seal is forced open. The layer of ink is adhered to a polyester film that is part of the seal. Before applying the ink, the polyester film is masked with a pre-determined pattern of a silicon oil releasing material, which normally causes the ink to break apart in the masked pattern when the seal is forced open. Also, to ensure that the ink layer adheres to the silicon oil releasing material and polyester film, a primer is applied over the silicon oil releasing material, and the ink is then applied over the primer. The most common type of tape available is often called VOID tape or evidence tape. When the tape is peeled away it leaves behind an adhesive residue that displays a VOID or OPENED message Unfortunately, such tamper evident tapes do not stick very strongly on substrates having very low surface energy and, on removal of tape, portions of adhesive left behind on such films can be easily cleaned using commonly available solvents. Easy availability of various types in the market accompanied with the fact that traces of adhesive, which is left behind on peeling this type of tapes, can be removed easily from Polyethylene surface makes them not suitable for application in very high security applications such as Polyethylene bags used by banks and duty free shops as the purpose of security can be defeated by peeling off the original tape, cleaning of left over adhesive markings and applying another similar looking tape, preferably of a wider width. By design/construction all of these security tapes are removable from the surface on which they are adhered and can only provide tamper evidence or tamper indication that something has been tamper with.

To overcome these limitations what is needed is a security tape which can not be removed once adhered on a surface including low energy surfaces such as Polyethylene and/or Polypropylene easily and/or comes in bits and pieces when attempted to remove by application of force, use of heat and/or use of solvents and thereby discouraging/resisting tampering and can be termed as tamper proof or tamper resistant.

### SUMMARY OF THE INVENTION

It is therefore an object of the present invention to provide a security sealing tape.

Another object of the invention is to provide a security tape which once applied, to any surface including low energy surface such as Polyethylene/Polypropylene bags, can not be removed, other than in bits and pieces, when attempted to remove by application of force, use of heat and/or use of solvents.

Further object of this invention is to provide a security tape that can be customized with unique printing and/or identification such as logos.

The present invention accordingly relates to a tamper resistant security sealing tape and the method of manufacturing the same. The said tape is a four or more layer adhesive tape based on a substrate which is a cast film/base substrate comprising of a blend of thermoplastic polyolefin resin copolymers such as ethylene vinyl acetate copolymers, thermoplastic acrylic copolymers, tackifying resins and plasticizers blended in such a ratio that gives low softening point to the composite and accordingly to the cast film thereof; the said cast film having unique features being highly fragile having very less tensile strength, dissolves to give tacky substance when brought in contact with commercially available solvents, such as hydrocarbon solvents, easters, ketones, alcohols, thinners, spirits, softens and coagulates when subjected to direct or indirect heat by any means such as hot knife, hot air, hot bulb, steam and can be either transparent, opaque white and/or specially pigmented such as sparking silver/bronze. One face of the said cast film is coated with a pressure sensitive adhesive having very high adhesive strength and is protected with a silicone coated release liner which can be a paper or film. The adhesive coated film along with release liner is slit to desired width and is converted in tape form. On the other surface of the said tape a strip of polymeric film with a width which is lower than the width of the said tape is laminated using pressure sensitive adhesive layer. Furthermore, the said tamper resistant security sealing tape of the invention is designed in such a way that economic individual printing of specific indicia or logo on the laminated polymeric film strip is possible to make it customer specific product and distinguish from commercially available look alike tapes.

The base substrate of the said tape is a formulated compound which is a blend of thermoplastic olefin co-polymers such as Ethylene Vinyl Acetate co-polymer, thermoplastic Acrylic co-polymer, tackifying resins of low softening point and optionally plasticizers, pigments such as white pigment in the form of titanium dioxide, sparkling silver pigment in the form of aluminum paste, sparkling bronze pigment. The said blend is dissolved in a aromatic hydrocarbon solvent such as Toluene/Hexane to give about 20% to 70% solids. The two co-polymers can be blended in the ratio of 10:3 to 10:1 and most preferably 10:2. The solution so prepared is coated on the silicone release resin coated substrate by conventional method of coating and drying equipment to form a uniform cast film. The cast film so obtained can have a thickness ranging from 80 to 115 microns. On one surface of the said cast film a layer of pressure sensitive adhesive having high tack is applied by the transfer adhesive coating technique for which the adhesive is first applied on the silicone resin coated liner and then dried by passing through a heated tunnel followed by lamination to exposed surface of the said cast film. The silicone resin coated substrate on which the said film was originally casted in a conventional coating and drying equipment to convert the said film into a pressure sensitive adhesive coated stock which forms the basic raw material for the manufacturing of the said tamper resistant security sealing tape.

The pressure sensitive adhesive is applied by process using conventional method of coating equipment followed by using known drying-methods to give a dry adhesive weight of 25 to 100 g/m² and preferably 45 to 55 g/m². This said pressure sensitive adhesive of this invention exhibits property of adhering to regular substrates as well as low energy surfaces like polypropylene, polyethylene etc and exhibits good adhesion even at low temperatures. The said adhesive is a solvent born adhesive manufactured by blending various materials comprising natural and/or synthetic rubbers, tackifying resins of natural/synthetic type, antioxidants followed by solvating with hydrocarbon/aromatic solvents to form a compound of proper consistency to facilitate coating and texture commensurate to the coating equipment. In the present invention, the said pressure sensitive adhesive includes a block co-polymeric rubber such as styrene-isoprene-styrene, a tackifier which can be either hydrocarbon resins, rosin and rosin derivatives, polyterpenes, coumarone-indene resins and/or any compatible conventional tackifier or mixtures thereof, where the rubber to resin ratio is 100:200 preferably 100:150, mineral oils which serve as plastisizers and aromatic solvents Toluene/Hexane etc.

The silicone release resin coated substrate used for casting of film and subsequent pressure sensitive adhesive coating could be either paper like Glassine, bleached kraft, polycoated kraft etc. or polymeric films like Polyester, Polyethylene etc.

The said stock formed as per the above process is slit in to desired width on conventional slitting machines utilizing crush cutting or shear cutting techniques to convert the said stock in to tape.

The said tape roll is then mounted on a flexo printing machine equipped with an unwind and windup stations for partial lamination of polymeric film strip on the non adhesive coated side of the said tape and printing indicia or logo on the said polymeric film strip, if desired to do so. The said polymeric film strip is separately produced by coating pressure sensitive adhesive on one side of the said polymeric film on conventional three roll coating machines or by application of dry adhesive layer in the form of transfer adhesive tape followed by slitting in to the desired width. The pressure sensitive adhesive layer applied on said polymeric film can be commercially available water based or solvent based rubber or acrylic adhesive. In one of the preferred embodiment of this invention the pressure sensitive adhesive used is the same adhesive which has been used for making the tape and has been described above. The said polymeric film strip could be a destructible or non destructible holographic film with general and/or customer specific holographic images embossed on it, metallised polyester film, metallised polyester film which on removal destructs in a pre-determined manner, transparent film such as polyester, polypropylene, polyethylene, poly vinyl chloride etc. which may or may not destruct when the said polymeric film strip is separated from the said tape. The said polymeric film could be of thickness ranging from 0.012 mm to 0.100 mm, however a film thickness of 0.025 mm to 0.05 mm is preferred for this invention. The said polymeric strip is laminated on to the said tape in its longitudinal direction in such a manner so as to cover part of the said tape preferably 20% to 60% of the width of the said tape and most preferably 30% to 40% of the said tape. The breaking strength of the said polymeric film used for partial lamination of the tape being higher than that of the base film of the tape of this invention, it provides the desired strength to the tape for easy application on automatic applicator machines. Furthermore, once applied on the surface the edges of the partially laminated polymeric film strip acts as junction point of two films having different breaking strengths and initiates tearing of the base substrate when attempted to force remove. Once tearing is initiated it is not possible to realign the tape back on the same place.

Optionally, to add more security features in the tape of this invention, to make customer specific product and to make it difficult for others to get it, the entire construction of the tape can be printed with a generic pattern and/or specific indicia or logo of the customer using regular flexo printing inks which can be water based, solvent based or UV curable inks on conventional printing machine.

The tamper resistant security sealing tape described in this invention is most suitable for use as sealing for security bags by banking industry or duty free shops. The said tape once applied to close the bag can not be removed in one piece due to the very low breaking strength of the base substrate along with very high adhesion pressure sensitive adhesive. The base substrate has a breaking strength which is less than the peel strength of the adhesive used. Further the adhesive used is suitable for very low temperature applications. The cast film used for making the tape apart from fragile also is sensitive to high temperature and commercially available solvents which are commonly used by fraudulent for counterfeiting securely packed containers. Strengthening of the tape with polymeric strip helps in handling the fragile tape on automatic applicators used by bag manufacturers also provides the initiation for tearing of the base film if attempted to remove with force. The tape is further made complicated for counterfeiters to get in open market by printing customer specific indicia of logo.

The following is the schematic representation of the construction of the tamper resistant security sealing tape

1. A tamper resistant security sealing tape having four or more layers comprising of a base substrate which is formed by coating a formulated compound, a pressure sensitive adhesive layer on the lower side of the said base substrate, a pressure sensitive adhesive coated polymeric film strip laminated only partially on the other side of the said base substrate, and an optional layer of indicia or logo as per specific customer requirement printed on the said polymeric film strip and/or the base substrate; and the said tape is manufactured by
(a) coating a formulated compound on a silicone release coated substrate by conventional coating methods followed by drying with conventional method to manufacture base substrate;
(b) coating high tack adhesive on another silicone release coated substrate by use of conventional coating methods followed by drying with conventional methods and laminating the said base substrate formed in step (a) to get the self adhesive label stock;
(c) slitting the said self adhesive label stock on conventional slitting machines utilizing crush cutting or shear cutting techniques to convert the said stock in to tape;
(d) coating another polymeric film with pressure sensitive adhesive on one side on conventional three roll coating machines followed by lamination to silicone release resin coated substrate or by application of dry adhesive layer in the form of transfer adhesive tape followed by slitting into strips of desired width;
(e) laminating polymeric film strips obtained in step (d) partially on the other side of the tape obtained in step (c) above on conventional printing machine;
(f) printing indicia or logo as per customer requirement on the polymeric film strip and/or base substrate using flexographic printing machine.

2. A tamper resistant security sealing tape and the process of manufacturing the same as claimed in claim 1, wherein the said formulated compound is a blend of thermoplastic olefin copolymers such as Ethylene Vinyl Acetate co-polymer and thermoplastic Acrylic co-polymer, tackifying resins of low softening point and optionally plasticizers, white pigment in the form of titanium dioxide, sparkling silver pigment in the form of aluminium paste etc. in a regular aromatic hydrocarbon solvent such as Toluene/Hexane to give about 20% to 70% solids.

3. A tamper resistant security sealing tape and the process of manufacturing the same as claimed in claim 2 and where the two co-polymers can be blended in the ratio of 10:3 to 10:1 and most preferably 10:2.

4. A tamper resistant security sealing tape and the process of manufacturing the same as claimed in claim 1 wherein the base substrate film has a breaking strength less than the adhesive strength of the pressure sensitive adhesive.

5. A tamper resistant security sealing tape and the process of manufacturing the same as claimed in claim 1 wherein the base substrate softens and melts on application of heat above 700 C and dissolves and forms tacky solution with commercially available solvents.

6. A tamper resistant security sealing tape and the process of manufacturing the same as claimed in claim 1, wherein the said pressure sensitive adhesive is a solvent based adhesive manufactured by blending various materials comprising natural and/or synthetic rubbers, tackifying resins of natural/synthetic type, antioxidants followed by solvating with hydrocarbon/aromatic solvents to form a compound of proper consistency to facilitate coating and texture commensurate to the coating equipment.

7. A tamper resistant security sealing tape and the process of manufacturing the same as claimed in claim 1 wherein the said pressure sensitive adhesive includes a block co-polymeric rubber such as styrene-isoprene-styrene, hydrocarbon resins tackifying resin, polyterpene resins, or mixture thereof, mineral oils as plastisizers and aromatic solvents Toluene/Hexane.

8. A tamper resistant security sealing tape and the process of manufacturing the same as claimed in claim 7 and where the rubber to resin ration is 100:200 preferably 100:150.

9. A tamper resistant security sealing tape and the process of manufacturing the same as claimed in claim 1 wherein the pressure sensitive adhesive used for laminating polymeric film strip can be a commercially available water based or solvent based rubber or acrylic adhesive or can include a block co-polymeric rubber such as styrene-isoprene-styrene, hydrocarbon resins tackifying resin, polyterpene resins, or mixture thereof, mineral oils as plastisizers and aromatic solvents Toluene/Hexane.

10. A tamper resistant security sealing tape as claimed in claim 1 wherein the pressure sensitive adhesive shows very high adhesion to any substrate including low surface energy substrates such as Polyethylene and Polypropylene.

11. A tamper resistant security sealing tape and the process of manufacturing the same as claimed in claim 1 wherein the said tape can be used at low temperature up to −400 C.

12. A tamper resistant security sealing tape and the process of manufacturing the same as claimed in claim 1 wherein the silicone resin coated release liner is one side or both side coated glassine paper, bleached kraft paper, polycoated kraft paper, polyester film.

13. A tamper resistant security sealing tape and the process of manufacturing the same as claimed in claim 1 wherein the polymeric film strip can be destructible or non destructible holographic film with general and/or customer specific holographic images embossed on it, metallised polyester film, metallised polyester film which on removal destructs in a predetermined manner, transparent film such as polyester, polypropylene, polyethylene, poly vinyl chloride etc. which may or may not destruct when the said polymeric film strip is separated from the said tape.

14. A tamper resistant security sealing tape and the process of manufacturing the same as claimed in claim 1 wherein the said polymeric film strip could be of thickness ranging from 0.012 mm to 0.100 mm, and is laminated on to the said tape in its longitudinal direction in such a manner so as to cover part of the said tape preferably 20% to 60% of the width of the said tape and most preferably 30% to 40% of the said tape.

15. A tamper resistant security sealing tape and the process of manufacturing the same as claimed in claim 1 wherein the printing of indicia and/or logo is done on flexographic printing machine using commercially available flexographic printing inks that may be water based, solvent based and/or UV curable ink. 16. A tamper resistant security sealing tape and the process of manufacturing the same as claimed in claim 1 whereby a tape having very high adhesion on low energy surfaces even at low temperatures and that can not be removed in one piece by means of forced peeling, use of heat and/or commercially available solvents thereby making it a tamper resistant security sealing tape is obtained.
